(19) United States
(12) Patent Application Publication
(10) Pub. No.: US 2023/0099113 A1
(43) Pub. Date: Mar. 30, 2023

(54) TRAINING METHOD AND APPARATUS FOR A TARGET DETECTION MODEL, TARGET DETECTION METHOD AND APPARATUS, AND MEDIUM

(71) Applicant: BEIJING BAIDU NETCOM SCIENCE TECHNOLOGY CO., LTD., Beijing (CN)

(72) Inventors: Xiaoqing YE, Beijing (CN); Xiao TAN, Beijing (CN); Hao SUN, Beijing (CN)

(73) Assignee: BEIJING BAIDU NETCOM SCIENCE TECHNOLOGY CO., LTD., Beijing (CN)

(21) Appl. No.: 17/807,371

(22) Filed: Jun. 16, 2022

(30) Foreign Application Priority Data
Sep. 29, 2021 (CN) 202111152678.8

(51) Int. Cl. G06N 3/08; G06N 3/04; G06V 10/77; G06V 10/82; G06T 7/50

(52) U.S. Cl. CPC G06N 3/08; G06N 3/0454; G06V 10/7715; G06V 10/82; G06T 7/50

(57) ABSTRACT

Provided are a training method and apparatus for a target detection model, a target detection method and apparatus, and a medium. A specific implementation includes inputting a sample image into a point cloud feature extraction network of a first target detection model to obtain an image feature of a generation point cloud; inputting the image feature of the generation point cloud into a first bird's-eye view feature extraction network of the first target detection model to obtain a first bird's-eye view feature; inputting the first bird's-eye view feature into a prediction network of the first target detection model to obtain a first detection result; and calculating a first loss according to a standard 3D recognition result of the sample image and the first detection result and training the first target detection model according to the first loss.

### CROSS-REFERENCE TO RELATED APPLICATION(S)

This application claims the priority to Chinese Patent Application No. CN202111152678.8 and filed on Sep. 29, 2021, the disclosure of which is incorporated herein by reference in its entirety.

### TECHNICAL FIELD

The present disclosure relates to the field of artificial intelligence, in particular, to computer vision and deep learning technologies, which may be applied to 3D visual scenes, and in particular, to a training method and apparatus for a target detection model, a target detection method and apparatus, a device, and a medium.

### BACKGROUND

Computer vision technology is precisely a function for giving a computer the visual recognition and localization of human beings. Through complex image calculations, the computer can identify and locate a target object.

3D target detection is mainly used for detecting 3D objects, where the 3D objects are generally represented by parameters such as spatial coordinates (x, y, z), dimensions (a length, a width, and a height), and an orientation angle.

### SUMMARY

The present disclosure provides a training method and apparatus for a target detection model, a target detection method and apparatus, a device, and a medium.

According to an aspect of the present disclosure, a training method for a target detection model is provided. The method includes the following.

A sample image is inputted into a point cloud feature extraction network of a first target detection model so as to obtain an image feature of a generation point cloud.

The image feature of the generation point cloud is inputted into a first bird's-eye view feature extraction network of the first target detection model so as to obtain a first bird's-eye view feature.

The first bird's-eye view feature is inputted into a prediction network of the first target detection model so as to obtain a first detection result.

A first loss is calculated according to a standard 3D recognition result of the sample image and the first detection result and the first target detection model is trained according to the first loss.

According to an aspect of the present disclosure, a target detection method is further provided. The method includes the following.

An image is inputted into a target detection model, and a 3D target space and a target category of the 3D target space are identified in the image.

The target detection model is trained and obtained according to the training method for a target detection model according to any embodiment of the present disclosure.

According to an aspect of the present disclosure, a training apparatus for a target detection model is provided. The apparatus includes at least one processor; and a memory communicatively connected to the at least one processor, wherein the memory stores instructions executable by the at least one processor, and the instructions are executed by the at least one processor to cause the at least one processor to perform steps in a generation point cloud feature extraction module, a bird's-eye view feature extraction module, a first detection result acquisition module, and a first loss calculation module.

The generation point cloud feature extraction module is configured to input a sample image into a point cloud feature extraction network of a first target detection model to obtain an image feature of a generation point cloud.

The bird's-eye view feature extraction module is configured to input the image feature of the generation point cloud into a first bird's-eye view feature extraction network of the first target detection model to obtain a first bird's-eye view feature.

The first detection result acquisition module is configured to input the first bird's-eye view feature into a prediction network of the first target detection model to obtain a first detection result.

The first loss calculation module is configured to calculate a first loss according to a standard 3D recognition result of the sample image and the first detection result and train the first target detection model according to the first loss.

According to an aspect of the present disclosure, a target detection apparatus is further provided. The apparatus includes at least one processor; and a memory communicatively connected to the at least one processor, wherein the memory stores instructions executable by the at least one processor, and the instructions are executed by the at least one processor to cause the at least one processor to perform steps in a 3D target detection module.

The 3D target detection module is configured to input an image into a target detection model and identify a 3D target space and a target category of the 3D target space in the image; where the target detection model is trained and obtained according to the training method for a target detection model according to any embodiment of the present disclosure.

According to another aspect of the present disclosure, a non-transitory computer-readable storage medium is provided, which stores computer instructions for causing a computer to perform the training method for a target detection model according to any embodiment of the present disclosure or the target detection method according to any embodiment of the present disclosure.

In embodiments of the present disclosure, the accuracy of target detection can be improved and the cost of target detection can be reduced.

It is to be understood that the content described in this part is neither intended to identify key or important features of the embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solution and not to limit the present disclosure.

FIG. 1 is a schematic diagram of a training method for a target detection model according to an embodiment of the present disclosure;

FIG. 2 is a schematic diagram of a training method for a target detection model according to an embodiment of the present disclosure;

FIG. 3 is a histogram of real value depth distribution provided according to an embodiment of the present disclosure;

FIG. 4 is a schematic diagram of candidate depth intervals according to an embodiment of the present disclosure;

FIG. 5 is a schematic diagram of a training method for a target detection model according to an embodiment of the present disclosure;

FIG. 6 is a training scene diagram of a target detection model according to an embodiment of the present disclosure;

FIG. 7 is a schematic diagram of a target detection method according to an embodiment of the present disclosure;

FIG. 8 is a schematic diagram of a training apparatus for a target detection model according to an embodiment of the present disclosure;

FIG. 9 is a schematic diagram of a target detection apparatus according to an embodiment of the present disclosure; and

FIG. 10 is a schematic diagram of an electronic device for implementing a training method for a target detection model or a target detection method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are merely illustrative. Therefore, it will be appreciated by those having ordinary skill in the art that various changes and modifications may be made to the embodiments described herein without departing from the scope and spirit of the present disclosure. Similarly, description of well-known functions and constructions is omitted hereinafter for clarity and conciseness.

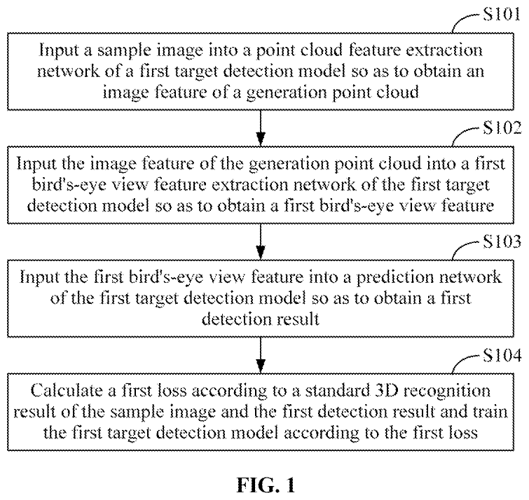

FIG. 1 is a flowchart of a training method for a target detection model according to an embodiment of the present disclosure. This embodiment may be applied to a case of training a target detection model for achieving 3D target detection. The method of this embodiment may be performed by a training apparatus for a target detection model. The apparatus may be implemented by software and/or hardware and is specifically configured in an electronic device having a certain data computing capability. The electronic device may be a client device or a server device. The client device is, for example, a mobile phone, a tablet computer, an in-vehicle terminal, a desktop computer and the like.

In S101, a sample image is inputted into a point cloud feature extraction network of a first target detection model so as to obtain an image feature of a generation point cloud.

The sample image is used for training a target detection model. The sample image is a monocular 2D image. The monocular image refers to an image taken at one angle, and the sample image does not have depth information. An image collection module performs collection in a set scene environment with a front view to obtain the sample image. For example, a camera on a vehicle collects road conditions ahead to obtain the sample image.

The first target detection model is used for identifying a 3D object according to a monocular image, specifically, identifying spatial attributes such as space key point coordinates, a space length, a space width, a space height, and a space orientation angle of the 3D object and determining a category of the 3D object. Exemplarily, the first target detection model may be a neural network model, which may include, for example, an encoding network, a classification network, and the like. The first target detection model is a pre-trained model, that is, a model that has been trained but has not reached a training target.

The point cloud feature extraction network is used for extracting an image feature from the sample image and determining the generation point cloud according to image pixels of the sample image, so as to form the image feature of the generation point cloud. The point cloud feature extraction network includes at least the encoding network and a depth prediction network. The encoding network is used for extracting the image feature; and the depth prediction network is used for predicting the depth information and determining the generation point cloud in conjunction with the image pixels. The point cloud refers to a set of three-dimensional coordinate points in a spatial coordinate system. The generation point cloud refers to a set of three-dimensional coordinate points forming an outer surface of at least one 3D object. The generation point cloud refers to a generated point cloud and is a pseudo point cloud indirectly generated based on other data, not a real point cloud. The image feature of the generation point cloud is actually a feature of an image extracted from the image pixels corresponding to the generation point cloud. In fact, the sample image has no depth information, and the real point cloud cannot be directly acquired. The generation point cloud determined based on the sample image is not the real point cloud. The image feature is extracted from the sample image, and a correspondence is established between the generation point cloud and the image feature so as to form the image feature of the generation point cloud.

In S102, the image feature of the generation point cloud is inputted into a first bird's-eye view feature extraction network of the first target detection model so as to obtain a first bird's-eye view feature.

Collection is performed in the set scene environment from a top-view angle so as to obtain an image, that is, a bird's-eye view The first bird's-eye view feature extraction network is used for extracting the first bird's-eye view (BEV) feature from the image feature of the generation point cloud. Exemplarily, the first bird's-eye view feature extraction network may be a sparsely embedded convolutional detection (SECOND) network or a point voxel detection network (PointPillars). The SECOND network may include a voxel grid feature extraction network, a sparse convolutional layer (an intermediate layer), and a region proposal network (RPN). In fact, the image feature may represent a feature of a 3D object in a front view, and the bird's-eye view feature may represent the feature of the 3D object in a top view. For example, in the sample image, 3D objects with different depths and overlapping each other are occluded, and the occluded 3D objects are difficult to identify accurately so that in the image feature, it is difficult to accurately distinguish the 3D objects that overlap and occlude each other in a depth direction. After the bird's-eye view feature is converted, since the set scene environment is generally flat, multiple 3D objects generally do not overlap each other in a height direction so that different 3D objects may be accurately distinguished through the bird's-eye view feature.

In S103, the first bird's-eye view feature is inputted into a prediction network of the first target detection model so as to obtain a first detection result.

The prediction network is used for outputting the first detection result according to the first bird's-eye view feature. The first detection result is a detection result of one 3D object.

Different 3D objects correspond to different first detection results. The 3D object may be represented by attribute information such as space key point coordinates, a space length, a space width, a space height, and a space orientation angle. The first detection result of the first target detection model may be defined as N_{A}×D, where D={LWH, XYZ, ry} denotes a 7-dimensional detection result, L denotes a length, W denotes a width, H denotes a height, XYZ denotes (object) center point coordinates, and ry denotes an orientation angle. N denotes a number of detected first detection results, and N_{A} denotes an A-th first detection result and also denotes an A-th 3D object identified, that is, N_{A} identifies the first detection result. One first detection result is projected onto a 2D image through a camera intrinsic parameter so that 8 projection points may be obtained, and a circumscribing region of the 8 projection points is determined to be a first detection region. The circumscribing region may be a circumscribing rectangle. The first detection region is a projection region of a determined 3D object in the image when the first target detection model performs 3D object recognition on the sample image.

In S104, a first loss is calculated according to a standard 3D recognition result of the sample image and the first detection result and the first target detection model is trained according to the first loss.

In a process of training the target detection model, a 3D object as a real value and a real category of the 3D object are generally configured, and the standard 3D recognition result is determined based on the 3D object and the category. In fact, the standard 3D recognition result is used as a real value of the first detection result to verify whether the first detection result is correct.

The first loss is used for constraining a difference between the first detection result and the standard 3D recognition result and training the first target detection model according to the first loss, thereby improving a 3D detection accuracy of the first target detection model.

Calculating the first loss may include: according to space key point coordinates in a spatial attribute of each first detection result and space key point coordinates in a spatial attribute of each standard 3D recognition result, acquiring a first detection result with the standard 3D recognition result as a real value and determining that the first detection result corresponds to the standard 3D recognition result; determining a space loss corresponding to each standard 3D recognition result according to the spatial attribute of each standard 3D recognition result and the spatial attribute of a corresponding first detection result, where the spatial attribute includes at least one of the following: a space length, a space width, a space height, or a space orientation angle; determining a category loss according to a first detection category of the first detection result and a target category of the standard 3D recognition result; and performing statistics to determine the first loss according to the space loss and the category loss corresponding to each standard 3D recognition result. A correspondence is established between a standard 3D recognition result and a first detection result with close space key point coordinates, where close space key point coordinates may indicate that a distance between two coordinates is less than or equal to a set distance threshold. In the case where the standard 3D recognition result does not have a corresponding first detection result, the first loss is calculated according to the standard 3D recognition result by taking the first detection result as empty.

The spatial attribute includes multiple elements and a vector may be generated according to the multiple elements. Exemplarily, calculating a difference between the spatial attribute of the standard 3D recognition result and the spatial attribute of the corresponding first detection result may include calculating a vector difference between the spatial attribute of the standard 3D recognition result and the spatial attribute of the corresponding first detection result, that is, calculating a space length difference, a space width difference, a space height difference, and a space orientation angle difference between the standard 3D recognition result and the corresponding first detection result, and determining the space loss of the first detection result. In the case where the standard 3D recognition result does not have a corresponding first detection result, the space loss of the standard 3D recognition result is determined according to a space length difference, a space with difference, a space height difference, and a space orientation angle difference between the standard 3D recognition result and an empty first detection result (a space length, a space width, a space height, and a space orientation angle may all be 0).

The category is used for representing a category of content in a region, for example, the category includes at least one of the following: vehicles, bicycles, trees, marking lines, pedestrians, or lights. Generally, the category is represented by a specified value. A numerical difference value corresponding to categories between the standard 3D recognition result and the corresponding first detection result may be calculated and determined to be the category loss of the standard 3D recognition result. In the case where the standard 3D recognition result does not have a corresponding first detection result, the category loss of the standard 3D recognition result is determined according to the numerical difference value corresponding to categories between the standard 3D recognition result and the empty first detection result (a value corresponding to a category is 0).

The space loss and the category loss of the aforementioned at least one standard 3D recognition result are accumulated so as to determine the first loss. The space loss of at least one standard 3D recognition result may be counted so as to obtain a space loss of the first target detection model, the category loss of at least one standard 3D recognition result may be counted so as to obtain a category loss of the first target detection model, and the space loss of the first target detection model and the category loss of the first target detection model are weighted and accumulated so as to obtain the first loss corresponding to the standard 3D recognition result. In addition, there are other accumulation methods, such as weighted summation or multiplication, which are not specifically limited.

In an existing monocular 3D detection method, a space surrounding the 3D object is detected based on the image. However, due to the lack of depth information in a single monocular image and a shooting problem of perspective projection that is, a near object looks big and a far object looks small, an accuracy of 3D detection based on the monocular image is low.

According to the technical solution of the present disclosure, the depth information is predicted through the sample image, the generation point cloud is determined, the image feature is extracted, and the image feature of the generation point cloud is obtained and converted into the first bird's-eye view feature so that 3D objects may be accurately distinguished in the depth direction, and the 3D objects are predicted based on the first bird's-eye view feature, thereby improving a target detection accuracy of the 3D objects.

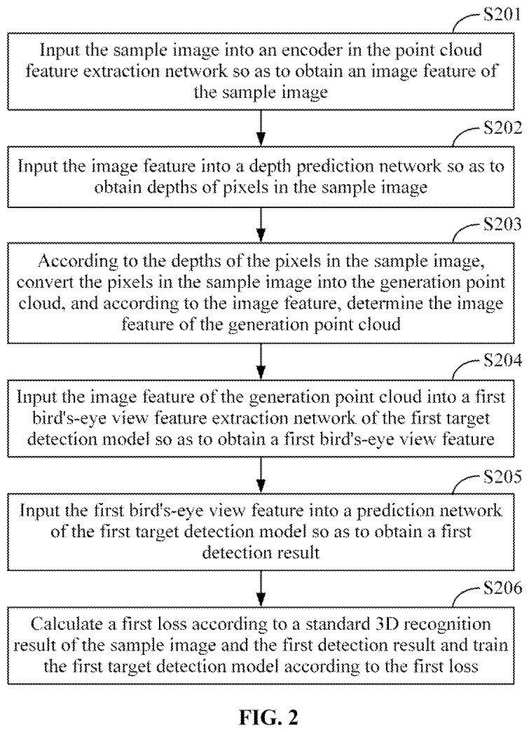

FIG. 2 is a flowchart of another training method for a target detection model according to an embodiment of the present disclosure. The training method for a target detection model is further optimized and extended based on the preceding technical solution and may be combined with the preceding various optional embodiments. Inputting the sample image into the point cloud feature extraction network of the first target detection model to obtain the image feature of the generation point cloud is embodied as: inputting the sample image into an encoder in the point cloud feature extraction network to obtain an image feature of the sample image; inputting the image feature into a depth prediction network to obtain depths of pixels in the sample image; and according to the depths of the pixels in the sample image, converting the pixels in the sample image into the generation point cloud, and according to the image feature, determining the image feature of the generation point cloud.

In S201, the sample image is inputted into an encoder in the point cloud feature extraction network so as to obtain an image feature of the sample image.

The encoder is a 2D encoder configured to extract an image feature from the sample image, and the extracted image feature is a 2D image feature. The image feature is used for determining the depths of the pixels in the sample image and determining a bird's-eye view feature.

In S202, the image feature is inputted into a depth prediction network so as to obtain depths of pixels in the sample image.

The depth prediction network is used for determining the depths of the pixels in the sample image according to the image feature. Exemplarily, the deep prediction network may include multiple convolutional layers and classification layers.

In S203, according to the depths of the pixels in the sample image, the pixels in the sample image are converted into the generation point cloud, and according to the image feature, the image feature of the generation point cloud is determined.

The pixels in the sample image may be represented by two-dimensional coordinate points, and the sample image may be defined as consisting of pixels, where each pixel is a two-dimensional coordinate point. The depth information is added based on the pixels so as to form three-dimensional coordinate points. The three-dimensional coordinate points are used for representing voxels, where voxel points forms a space. Therefore, it is possible to convert the two-dimensional coordinate points into the three-dimensional coordinate points and convert the pixels in the sample image into voxels.

Exemplarily, the camera intrinsic parameter is K, an image coordinate system is an uv axis, a predicted depth map is D(u, v), and a point in the sample image is I(u, v). The camera intrinsic parameter and the depth map are converted into three-dimensional coordinate points based on formulas described below.

$$K = [ \begin{matrix}{f}_{x} & 0 & {c}_{x} \\ 0 & {f}_{y} & {c}_{y} \\ 0 & 0 & 1\end{matrix} ]$$

$$D [ \begin{matrix}u \\ v \\ 1\end{matrix} ] = {KP}_{c} = [ \begin{matrix}{f}_{x} & 0 & {c}_{x} \\ 0 & {f}_{y} & {c}_{y} \\ 0 & 0 & 1\end{matrix} ] [ \begin{matrix}x \\ y \\ z\end{matrix} ]$$

Therefore, a corresponding three-dimensional coordinate point Pc is described below.

$${P}_{c} = {DK}^{- 1} [ \begin{matrix}u \\ v \\ 1\end{matrix} ] = {[ \begin{matrix}{f}_{x} & 0 & {c}_{x} \\ 0 & {f}_{y} & {c}_{y} \\ 0 & 0 & 1\end{matrix} ]}^{- 1} [ \begin{matrix}u \\ v \\ 1\end{matrix} ]$$

Multiple three-dimensional coordinate points are calculated so as to form the generation point cloud. According to the image feature of the sample image, the image feature of the generation point cloud is determined. A correspondence exists between the image feature of the sample image and a pixel in the sample image, and the pixels in the sample image may be converted into the generation point cloud. Correspondingly, an image feature corresponding to a pixel converted into a three-dimensional coordinate point may be determined to be the image feature of the three-dimensional coordinate point, and image features of three-dimensional coordinate points that form the generation point cloud are determined to be the image feature of the generation point cloud. In fact, the sample image is processed so that the image feature is obtained. A correspondence exists between a dimension of the image feature and a dimension of the sample image. According to the dimension correspondence, a correspondence between the pixel and the image feature is determined. For example, the dimension of the image feature is 20*20, and the dimension of the sample image is 40*40. Correspondingly, 4 pixels in the sample image correspond to a same feature point in the image feature, and a three-dimensional coordinate point into which one of the 4 pixels is converted corresponds to the feature point in the image feature. Correspondingly, a feature formed by feature points corresponding to the three-dimensional coordinate points that form the generation point cloud is determined to be the image feature of the generation point cloud. The image feature of the generation point cloud actually includes spatial coordinates of a recognizable 3D object in the sample image and an image feature of the 3D object projected onto a plane where the sample image is located.

Optionally, inputting the image feature into the depth prediction network to obtain the depths of the pixels in the sample image includes inputting the image feature into the depth prediction network and determining depth prediction confidences corresponding to the pixels in the sample image in preset candidate depth intervals; and calculating the depths of the pixels according to intermediate depth values of the candidate depth intervals and the depth prediction confidences corresponding to the pixels in the candidate depth intervals.

The depth prediction network is used for classifying the depths of the pixels according to the image feature, specifically, a probability that a depth of an image feature detection pixel falls within at least one preset candidate depth interval. The intermediate depth value of the candidate depth interval is used for representing a depth value represented by the candidate depth interval. The intermediate depth value of the candidate depth interval may refer to a median within the candidate depth interval, for example, half of a sum of depth values of two endpoints of the candidate depth interval. The depth prediction confidence is used for describing a degree of confidence that a depth of a pixel belongs to a certain candidate depth interval and may refer to a probability that the depth of the pixel belongs to a certain candidate depth interval.

Exemplarily, a depth D of a pixel may be calculated based on the formula described below.

D=Σᵢ₌₁^{N}wᵢ*binᵢ

binᵢ denotes an intermediate depth value of an i-th candidate depth interval, and wᵢ denotes a confidence of the i-th candidate depth interval may also be referred to as a weight of the i-th candidate depth interval. N denotes a number of candidate depth intervals.

A confidence that the depth of the pixel belongs to the candidate depth interval is predicted, and the depth is not directly estimated so that an error review due to direct depth estimation may be reduced. The depth prediction is converted into a classification problem that the depth belongs to a certain candidate depth interval, thereby improving the robustness of the depth prediction network, reducing a depth prediction error, and improving an accuracy of depth prediction.

Optionally, the training method for a target detection model further includes acquiring a collection point cloud, where the collection point cloud and the sample image correspond to a same collection scene; acquiring a point cloud of interest in the collection point cloud; and according to a depth of the point cloud of interest, dividing a depth of the collection scene corresponding to the collection point cloud into intervals and determining the candidate depth intervals.

The collection scene refers to a space ahead. Exemplarily, the collection scene is a cuboid with a length of 70 meters, a width of 30 meters, and a height of 30 meters, where the length is a depth range, and the width and height determine a dimension of a collection region corresponding to the sample image. The monocular image collection module performs collection in the collection scene with a front view to obtain the sample image. The collection point cloud is collected by a radar in the collection scene. Points on a surface of a 3D object are collected so as to obtain a real point cloud, that is, the collection point cloud.

The point cloud of interest is a set formed by three-dimensional coordinate points of an outer surface of a 3D object of interest. The point cloud of interest includes at least one 3D object of interest. The 3D object of interest refers to a specified 3D object that needs to be identified. Exemplarily, the collection scene includes an indicator light, a pedestrian, and a vehicle, and 3D objects of interest may be the indicator light and the vehicle. 3D objects in the collection point cloud are screened, so as to obtain three-dimensional coordinate points of at least one 3D object of interest, thereby forming a point cloud of interest. Exemplarily, a neural network model may be pre-trained so as to obtain a point cloud classification model, and collection point clouds may be classified and screened according to the point cloud classification model so as to obtain the point cloud of interest.

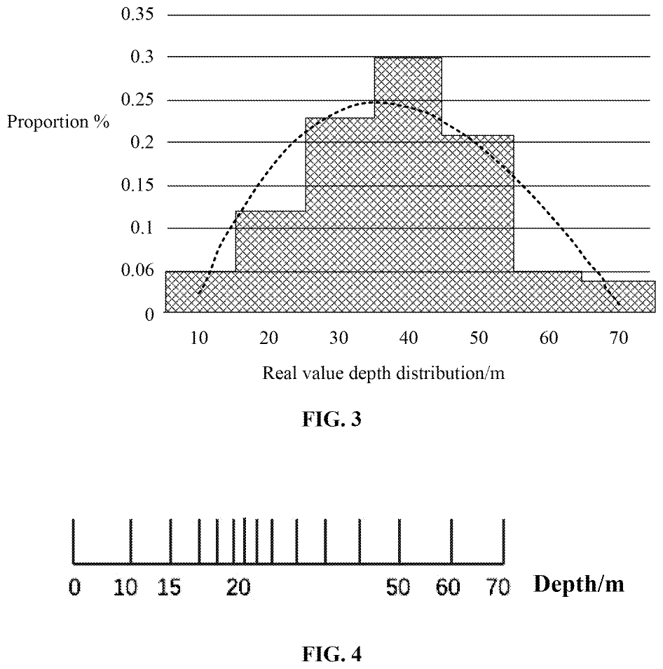

The depth of the point cloud of interest refers to depths of three-dimensional coordinate points included in the point cloud of interest. The depth of the point cloud of interest is used for determining distribution of the three-dimensional coordinate points included in the point cloud of interest, so as to determine the candidate depth intervals. As shown in a depth histogram shown in FIG. 3, the distribution of the three-dimensional coordinate points included in the point cloud of interest presents a normal distribution. The depth of the collection scene refers to a length of a space corresponding to the collection scene. As in the preceding example, a length of the space is 70 meters so that the depth of the collection scene is 70 meters. Interval division of the depth of the collection scene corresponding to the collection point cloud may refer to the division of depth intervals from 0 to the depth of the collection scene. The interval division is performed according to the depth of the point cloud of interest. It may be that, according to a proportion of a depth of each three-dimensional coordinate point included in each point cloud of interest in a depth interval, a number of intervals divided at positions with a high proportion of the depth is large, that is, the intervals are finely divided; and a number of intervals divided at positions with a low proportion of the depth is small, that is, the intervals are coarsely divided. The divided depth intervals are determined to be the candidate depth intervals.

For example, a ratio of a number of three-dimensional coordinate points at a depth of (55, 65) to a total number of three-dimensional coordinate points is 30%, and a ratio of a number of three-dimensional coordinate points at a depth of (65, 75] to the total number of three-dimensional coordinate points is 10%; correspondingly, (55,65] may be divided into three intervals, such as (55,58], (58,61] and (61,65], and (65,75] may be divided into one interval, that is, (65,75]. According to the depth histogram in FIG. 3, correspondingly divided candidate depth intervals may be shown in FIG. 4. For example, a distribution of a depth of 40 meters accounts for the highest proportion, intervals near the depth of 40 meters are the most finely divided, and candidate depth intervals obtained by the division are the most. For another example, a distribution of a depth of 70 meters accounts for the lowest proportion, intervals near the depth of 70 meters are the most coarsely divided, and candidate depth intervals obtained by the division is the least.

The collection point cloud is obtained by radar collection in the collection scene, the point cloud of interest is obtained by screening, a depth range of the collection scene is divided into intervals according to the depth of each three-dimensional coordinate point in the point cloud of interest, and the candidate depth intervals are obtained. The candidate depth intervals may be determined according to a density of a depth distribution of the point cloud of interest, and the three-dimensional coordinate points may be evenly distributed in different candidate depth intervals so that the candidate depth interval to which the depth of the pixel belongs is determined, and detected candidate depth intervals may be made independent of positions of the intervals. In this manner, a confidence of a detected candidate depth interval may accurately characterize a probability that a depth of a pixel belongs to the candidate depth interval, thereby improving a classification accuracy of the candidate depth intervals and improving a prediction accuracy of the depths of the pixels.

In S204, the image feature of the generation point cloud is inputted into a first bird's-eye view feature extraction network of the first target detection model so as to obtain a first bird's-eye view feature.

In S205, the first bird's-eye view feature is inputted into a prediction network of the first target detection model so as to obtain a first detection result.

In S206, a first loss is calculated according to a standard 3D recognition result of the sample image and the first detection result and the first target detection model is trained according to the first loss.

According to the technical solution of the present disclosure, the depths of the pixels in the sample image are predicted according to the image feature of the sample image, the pixels are converted into three-dimensional coordinate points based on the depths of the pixels, the generation point cloud is determined, and the image feature of the generation point cloud is formed and converted into the first bird's-eye view feature, so as to obtain a 3D target detection result. Depth information may be added to a monocular 2D image so that different overlapping 3D objects may be distinguished in the depth direction, thereby improving a recognition precision and accuracy of the 3D objects.

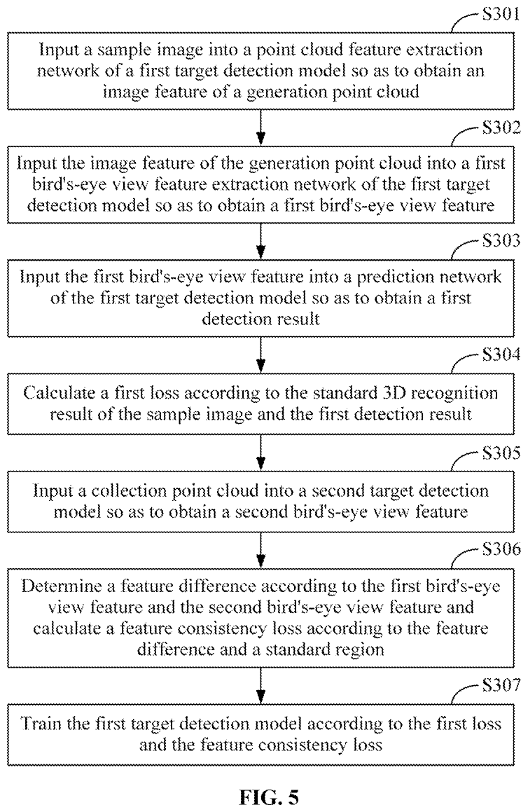

FIG. 5 is a flowchart of another training method for a target detection model according to an embodiment of the present disclosure. The training method for a target detection model is further optimized and extended based on the preceding technical solution and may be combined with the preceding various optional embodiments. The training method for a target detection model is optimized as follows: inputting a collection point cloud into a second target detection model to obtain a second bird's-eye view feature; and determining a feature difference according to the first bird's-eye view feature and the second bird's-eye view feature and calculating a feature consistency loss according to the feature difference and a standard region, where the standard region is a region where the standard 3D recognition result is projected in the sample image. Moreover, training the first target detection model according to the first loss is embodied as: training the first target detection model according to the first loss and the feature consistency loss.

In S301, a sample image is inputted into a point cloud feature extraction network of a first target detection model so as to obtain an image feature of a generation point cloud.

In S302, the image feature of the generation point cloud is inputted into a first bird's-eye view feature extraction network of the first target detection model so as to obtain a first bird's-eye view feature.

In S303, the first bird's-eye view feature is inputted into a prediction network of the first target detection model so as to obtain a first detection result.

In S304, a first loss is calculated according to the standard 3D recognition result of the sample image and the first detection result.

In S305, a collection point cloud is inputted into a second target detection model so as to obtain a second bird's-eye view feature.

The second target detection model is used for identifying a 3D object according to a point cloud, and specifically identifying information such as space key point coordinates, a space length, a space width, a space height, and a space orientation angle of the 3D object. The second target detection model has completed training. The first target detection model and the second target detection model have different structures. Generally, a prediction accuracy of the second target detection model is higher than a prediction accuracy of the first target detection model, but a running speed and training speed of the second target detection model are lower than a running speed and training speed of the first target detection model, and an input of the second target detection model is a point cloud that needs to be collected by a radar. An input of the first target detection is a monocular 2D image, which may be achieved by only one camera, and a collection cost of input data of the second target detection model is higher than a collection cost of input data of the first target detection model.

The input of the second target detection model is the point cloud, an output of the second target detection model is a spatial attribute and category of a 3D object, and an intermediate feature is a BEV_{cloud}, specifically, WB×HB×C. For the intermediate feature BEV_{cloud}, a lightweight 2D feature extraction network is used for obtaining L layers of second bird's-eye view features BEV_{cloud}^{k}, where k=1, 2, 3, . . . , and K. The intermediate feature BEV_{cloud} may be understood as a layer of second bird's-eye view feature, and the L layers of second bird's-eye view features BEV_{cloud}^{k} are multiple layers of second bird's-eye view features.

In S306, a feature difference is determined according to the first bird's-eye view feature and the second bird's-eye view feature and a feature consistency loss is calculated according to the feature difference and a standard region, where the standard region is a region where the standard 3D recognition result is projected in the sample image.

The feature difference may refer to a difference between the first bird's-eye view feature and the second bird's-eye view feature. The feature difference is used for indicating a difference between the first bird's-eye view feature and the second bird's-eye view feature. The feature consistency loss is used for constraining a difference between a bird's-eye view feature learned by the first target detection model and a bird's-eye view feature learned by the second target detection model so that the bird's-eye view feature learned by the first target detection model is closer to the bird's-eye view feature learnt by the second target detection model. A standard 3D object is projected onto the plane where the sample image is located so that 8 projection points are obtained, and a circumscribing region of the 8 projection points is determined to be the standard region where the standard 3D object is projected in the sample image.

The feature consistency loss is calculated according to the feature difference and the standard region. It is feasible that the feature difference is multiplied by the standard region so as to obtain the feature consistency loss. Alternatively, the standard region may be enlarged, and the feature consistency loss may be calculated according to the feature difference and the standard region. It is feasible that the feature difference is multiplied by the enlarged standard region so as to obtain the feature consistency loss. Increasing the standard region may refer to determining a circumscribing width and splicing pixels of the circumscribing width outward on the standard region to form the enlarged standard region. Exemplarily, the circumscribing width is 5 pixels.

Optionally, the first bird's-eye view feature includes a feature outputted by at least one first feature layer in the first bird's-eye view feature extraction network; the second target detection model includes a second bird's-eye view feature extraction network, the second bird's-eye view feature includes a feature outputted by at least one second feature layer in the second bird's-eye view feature extraction network, and the at least one first feature layer corresponds to the at least one second feature layer. Determining the feature difference according to the first bird's-eye view feature and the second bird's-eye view feature includes according to a difference between the feature outputted by the at least one first feature layer and the feature outputted by the corresponding at least one second feature layer, calculating a difference corresponding to the at least one first feature layer and determining the feature difference.

The first target detection model includes the first bird's-eye view feature extraction network, and the second target detection model includes the second bird's-eye view feature extraction network. The first bird's-eye view feature extraction network and the second bird's-eye view feature extraction network have similar network structures, different inputs, and same outputs. The first bird's-eye view feature extraction network generates the first bird's-eye view feature according to the image feature of the generation point cloud. The second bird's-eye view feature extraction network generates the second bird's-eye view feature according to the collection point cloud. The first bird's-eye view feature extraction network and the second bird's-eye view feature extraction network include the same number of feature layers. An i-th feature layer of the first bird's-eye view feature extraction network corresponds to an i-th feature layer of the second bird's-eye view feature extraction network.

Correspondingly, the feature difference may refer to a difference between the first bird's-eye view feature of at least one feature layer and the second bird's-eye view feature of the same feature layer. The feature consistency loss is calculated according to the feature difference and the standard region. It is feasible that the feature difference of at least one feature layer is accumulated and multiplied by the enlarged standard region so as to obtain the feature consistency loss.

The feature consistency loss may be calculated based on the formula described below.

$${L}_{feature} = {M}_{fg} * {‖ {F}_{{BEV}_{img}^{k}} - {F}_{{BEV}_{cloud}^{k}} ‖}_{L 2}$$

$${F}_{{BEV}_{img}^{k}}$$

denotes the first bird's-eye view feature of a k-th layer,

$${F}_{{BEV}_{cloud}^{k}}$$

denotes the second bird's-eye view feature of the k-th layer. Exemplarily, k is greater than or equal to 1 and less than or equal to K, where K is a total number of feature layers. M_{fg} denotes to an extended foreground region, that is, the enlarged standard region formed by splicing the circumscribing width (n pixels) outward in the foreground region.

The first bird's-eye view feature of at least one feature layer of the first target detection model and the second bird's-eye view feature of a corresponding feature layer of the second target detection model are calculated so as to determine the feature consistency loss, and for at least one layer of subdivided bird's-eye feature, at least one layer of bird's-eye view feature learned by the first target detection model in an image feature of a generated pseudo point cloud is closer to at least one layer of bird's-eye view feature learned by the second target detection model in a real point cloud. In this manner, a gap between a capability of the first target detection model learning the bird's-eye view feature in the image feature of the generated pseudo point cloud and a capability of the second target detection model learning the bird's-eye view feature in the real point cloud is greatly reduced, and the capability of the first target detection model learning the feature in the image feature of the generated pseudo point cloud is precisely improved so that each layer of bird's-eye view feature extracted by the first target detection model is more in line with a real bird's-eye view feature, thereby improving the prediction accuracy of the first target detection model.

Optionally, at least one feature layer is determined according to a number of training iterations. Exemplarily, in a training process, a progressive training method may be adopted, and it is assumed that from a feature of a first layer to a feature of a k-th layer, features are closer to the output layer. A method of adding feature layers in at least one feature layer is a reversely adding method, that is, an adjacent previous feature layer is added from the last feature layer. According to the number of training iterations, corresponding feature layers are added in a reverse order so as to calculate the feature consistency loss.

The number of training iterations is less than a first threshold of training iterations, and at least one feature layer is the last feature layer, that is, k is K; with the increase of the number of training iterations, the feature consistency loss of a (k=K−2)-th feature layer is gradually added until the feature consistency loss of a (k=1)-th feature layer is added at the end. Exemplarily, if the number of training iterations is greater than or equal to the first threshold of training iterations and less than a second threshold of training iterations, based on the feature consistency losses of the preceding feature layers, feature consistency losses of feature layers in a range greater than or equal to the first threshold of training iterations and less than the second threshold of training iterations are added.

Corresponding feature layers are added in a reverse order according to the number of training iterations so as to calculate the feature consistency loss. A progressive feature distribution may guide a feature learning capability of the first target detection model to continuously approach a feature learning capability of the second target detection model so that a learning requirement of the first target detection model may be prevented form exceeding the learning capability of the first target detection model, and a training effect of the first target detection model is prevented from being reduced, thereby achieving a training stability of the first target detection model and accurately improving a 3D object detection accuracy of the first target detection model.

In S307, the first target detection model is trained according to the first loss and the feature consistency loss.

The feature consistency loss and the first loss are determined to be a total loss of the first target detection model, and the first target detection model is trained with the total loss of the first target detection model as a training object.

Optionally, the first detection result includes a first category confidence; the method further includes inputting the collection point cloud into the second target detection model to obtain a second detection result, where the second detection result includes a second category confidence; and in the case where the first detection result matches the second detection result, according to the first category confidence included in the first detection result and the second category confidence included in the second detection result, calculating a confidence loss of the first detection result and determining a confidence consistency loss; training the first target detection model according to the first loss and the feature consistency loss includes training the first target detection model according to the first loss, the feature consistency loss, and the confidence consistency loss.

The second detection result is a 3D target detection result identified by the second target detection model according to the collection point cloud. The second detection result may include batches, 3D objects, and categories of the 3D objects. The second detection result may be defined as B×N×C, where B denotes a batch, and N denotes an N-th second detection result and also denotes an N-th 3D object. C denotes a category of a 3D object.

The category confidence is used for determining a confidence level of a detection category of a detection result. The category confidence may refer to a probability that the detection category of the detection result is a certain category. Generally, detection results are classified, and each category corresponds to one category confidence, according to each category confidence, a category is selected as a detection category, and a corresponding confidence is determined to be the category confidence. The selected category may be a category with a highest confidence. Generally, the first target detection model determines a category corresponding to the highest category confidence to be the first detection category and determines the highest category confidence to be the first category confidence; and the second target detection model determines a category corresponding to the highest category confidence to be a second detection category and determines the highest category confidence to be the second category confidence.

The matching of the first detection result and the second detection result means that the first detection result and the second detection result represent the same 3D object, and category confidences of included detection categories are all greater than a preset category confidence threshold.

It is to be understood that a difference in determined confidences between the first detection result and the second detection result representing different 3D objects cannot make the first target detection model learn category features that are more accurate. Therefore, it is necessary to compare detection results representing the same 3D object so that the first target detection model continuously learns to reduce the gap, thereby improving a recognition accuracy of the first target detection model for the 3D object category. Whether the first detection result and the second detection result represent a same 3D object may be detected through an intersection over union (IOU) between regions where two detection results are projected onto the sample image. Exemplarily, according to a spatial attribute of the first detection result, the first detection result is projected onto the plane where the sample image is located so that 8 projection points are obtained, and a circumscribing region of the 8 projection points is determined to be the first detection region where the first detection result is projected onto the sample image. According to a spatial attribute of the second detection result, the second detection result is projected onto the plane where the sample image is located so that 8 projection points are obtained, and a circumscribing region of the 8 projection points is determined to be a second detection region where the second detection result is projected onto the sample image. An IOU between the first detection region and the second detection region is calculated based on the formula described below.

$$I O U = \frac{{box}_{1} ⋂ {box}_{2}}{{box}_{1} ⋃ {box}_{2}}$$

box₁ denotes the first detection region, and box₂ denotes the second detection region. A numerator in the above formula is an area of an intersection of the first detection region and the second detection region, and a denominator in the above formula is an area of a union of the first detection region and the second detection region. In the case where the IOU is greater than a set IOU threshold, it is determined that the first detection result and the second detection result represent a same 3D object; and in the case where the IOU is less than or equal to the set IOU threshold, it is determined that the first detection result and the second detection result represent different 3D objects. Exemplarily, the IOU threshold is 0.7.

A category confidence of a detection category included in a detection result is greater than the preset category confidence threshold, indicating that the detection category is credible. It is to be understood that in the detection result, the category confidence of the detection category is relatively low, indicating that the model believes that the detection category is inaccurate. In this case, if the model is made to learn continuously, the first target detection model is caused to fail to learn category features that are more accurate. Therefore, detection categories of two detection results need to be credible. In this case, the first target detection model may be made to learn continuously so as to reduce the gap, thereby improving the recognition accuracy of the first target detection model for the 3D object category. Exemplarily, the first category confidence of the first detection category included in the first detection result is greater than the preset category confidence threshold, and the second category confidence of the second detection category included in the second detection result is greater than the preset category confidence threshold. For example, the category confidence threshold may be 0.3.

For example, in the case where the IOU between the first detection region where the first detection result is projected onto the sample image and the second detection region where the second detection result is projected onto the sample image is greater than a preset IOU threshold, the first category confidence of the first detection category is greater than the preset category confidence threshold, and the second category confidence of the second detection category is greater than the preset category confidence threshold, it is determined that the first detection result matches the second detection result.

The confidence consistency loss is used for constraining a difference between a category confidence learned by the first target detection model for a certain standard 3D recognition result and a category confidence learned by the second target detection model for the standard 3D recognition result so that the category confidence learned by the first target detection model for the standard 3D recognition result is closer to the category confidence learned by the second target detection model for the standard 3D recognition result. The confidence consistency loss is determined according to a difference between category confidences calculated by the first target detection model and the second target detection model respectively for a same standard 3D recognition result.

The confidence consistency loss may be determined based on a difference between a confidence of the first detection result of the first target detection model for the standard 3D recognition result and a confidence of the second detection result of the second target detection model for the standard 3D recognition result. For each first detection result and a matching second detection result, a confidence difference between the first category confidence of the first detection result and the second category confidence of the matching second detection result may be calculated, and confidence differences between multiple first detection results and matching second detection results are calculated, so as to calculate the confidence consistency loss.

The confidence consistency loss L_{cls_consi} may be calculated based on the formula described below.

L_{cls_consi}=smoothL1(∥score_{BEV}−score_{img}∥)

SmoothL1 denotes an absolute loss function, which represents a smooth L1 loss, score_{img} denotes the first category confidence, and score_{BEV} denotes the second category confidence. score_{BEV}−score_{img} denotes confidence differences between multiple first detection results and matching second detection results.

The confidence consistency loss is introduced, the confidence consistency loss, the feature consistency loss and the first loss are determined to be the total loss of the first target detection model, and the first target detection model is trained with the total loss of the first target detection model as a training object.

Correspondingly, the total loss L is calculated based on the formula described below.

L=L_{box3d}+L_{class}+L_{cls_consi}+L_{feature}

The second target detection model is additionally configured, and the first category confidence of the first target detection model and the second category confidence of the second target detection model are calculated, and the confidence consistency loss is determined so that a category feature learned by the first target detection model in a certain 3D object is closer to a category feature learned by the second target detection model in the same 3D object, thereby reducing a gap between a capability of the first target detection model learning the category feature and a capability of the second target detection model learning the category feature, improving the capability of the first target detection model learning the category feature, and improving a category prediction accuracy of the first target detection model.

According to the technical solution of the present disclosure, the first bird's-eye view feature of the first target detection model and the second bird's-eye view feature of the second target detection model are calculated so as to determine the feature consistency loss so that a bird's-eye view feature learned by the first target detection model in the image feature of the generated pseudo point cloud is closer to the bird's-eye view feature learned by the second target detection model in the real point cloud. In this manner, the gap between the capability of the first target detection model learning the bird's-eye view feature in the image feature of the generated pseudo point cloud and the capability of the second target detection model learning the bird's-eye view feature in the real point cloud is reduced, and the capability of the first target detection model learning the feature in the image feature of the generated pseudo point cloud is improved so that the bird's-eye view feature extracted by the first target detection model from the image feature of the pseudo point cloud is more in line with the real bird's-eye view feature, thereby improving the prediction accuracy of the first target detection model.

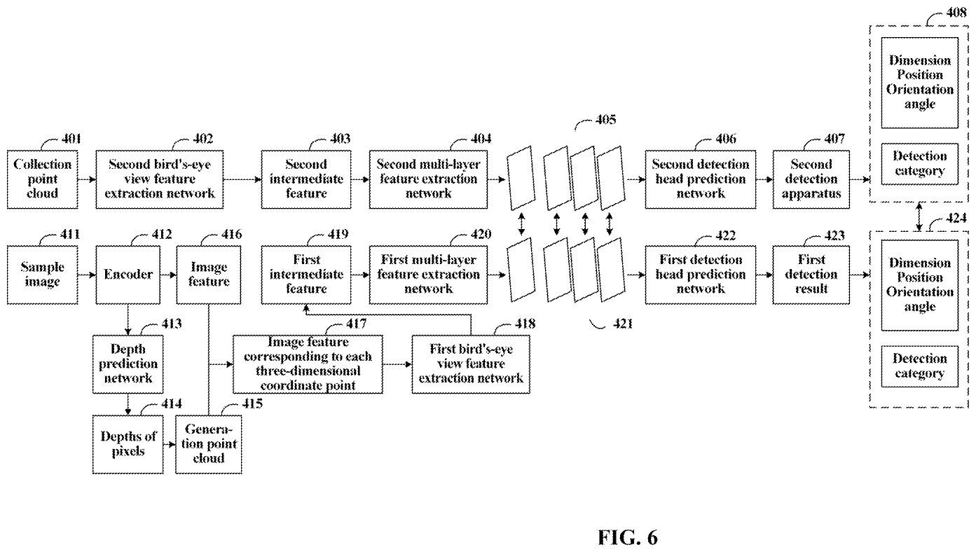

FIG. 6 is a training scene diagram of a target detection model according to an embodiment of the present disclosure.

As shown in FIG. 6, a sample image 408 is inputted into a first target detection model, and a collection point cloud 401 is inputted into a second target detection model. A feature consistency loss between a second bird's-eye view feature during an operation of the second target detection model and a first bird's-eye view feature during an operation of the first target detection model and a confidence consistency loss between the a second category confidence of a second detection result obtained by the second target detection model and a first category confidence of a first detection result obtained by the first target detection model are used as an added training target for training the first target detection model. The second target detection model is a pre-trained model and does not need to be trained in this process, and parameters of the second target detection model are fixed.

The second target detection model includes a second bird's-eye view feature extraction network 402, a second multi-layer feature extraction network 404, and a second detection head prediction network 406. A detection process of the second target detection model includes the following steps: the collection point cloud 401 is input into the second bird's-eye view feature extraction network 402 to obtain a second intermediate feature 403, the second intermediate feature 403 is input into the second multi-layer feature extraction network 404 to obtain a multi-layer second bird's-eye view feature 405, and the multi-layer second bird's-eye view feature 405 is input into the second detection head prediction network 406 to obtain a second detection result 407. The second detection result 407 includes second spatial attributes such as a dimension, a position, and an orientation angle of a 3D object, a second detection category of the 3D object, and a second confidence corresponding to the second detection category. The second spatial attributes and the second confidence form an element 408, where the position refers to space key point coordinates, and the dimension refers to a space length, a space width, and a space height.

The first object detection model includes an encoder 412, a depth prediction network 413, a first bird's-eye view feature extraction network 418, a first multi-layer feature extraction network 420, and a first detection head prediction network 422. A detection process of the first target detection model includes the following steps: a sample image 411 is input into the encoder 412 to obtain an image feature 416; the image feature 416 is input into the depth prediction network 413 to obtain a classification probability of pixels in each candidate depth interval; a pixel point depth 414 is calculated, a generation point cloud 415 is formed according to the pixel point depth 414, the pixels of the sample image, and camera intrinsic parameters; an image feature 417 corresponding to each three-dimensional coordinate point in the generation point cloud is determined according to the image feature 416 and the generation point cloud 415; the image feature 417 is input into the first bird's-eye view feature extraction network 418 to obtain a first intermediate feature 419; the first intermediate feature 419 is input into the first multi-layer feature extraction network 420 to obtain a multi-layer first bird's-eye view feature 421; and the multi-layer first bird's-eye view feature 421 is input into the first detection head prediction network 422 to obtain a first detection result 423. The first detection result 423 includes first spatial attributes such as a dimension, a position, and an orientation angle of a 3D object, a first detection category of the 3D object, and a first confidence corresponding to the first detection category. The first spatial attributes and the first confidence form an element 424.

According to the number of training iterations, feature layers for calculating the feature consistency loss are determined and are gradually added from the last layer forward. According to at least one determined feature layer, a feature difference between the first bird's-eye view feature outputted by the at least one feature layer and the second bird's-eye view feature outputted by the corresponding feature layer is calculated, accumulated, and multiplied by the enlarged standard region, so as to determine the feature consistency loss. Since at least one standard region exists, all enlarged the second target detection may form a standard map, which is multiplied by the feature difference to obtain the feature consistency loss.

Multiple first detection results 423 and matching second detection results 407 are acquired. For each first detection result and a matching second detection result, a confidence difference between a first detection category 424 and a corresponding second detection category 408 is calculated, and confidence differences between multiple first detection results and matching second detection results are calculated, so as to calculate the confidence consistency loss.

According to the first detection result 423 and the standard 3D recognition result, a space loss and a category loss of the first detection result are calculated, so as to determine the first loss.

Parameters of the first target detection model are adjusted according to a sum of the feature consistency loss, the confidence consistency loss and the first loss. The second target detection model is only used in a training stage, and in an application stage of the first target detection model, training content associated with the second target detection model is eliminated.

The training of the first target detection model is guided by the second target detection model, and in a testing stage, it is only necessary to provide the bird's-eye view feature extracted from the point cloud that are actually collected to guide the first target detection model to learn and extract the real bird's-eye view feature. The confidence consistency of categories of the first target detection model and the second target detection model are constrained so that a capability of the first target detection model learning the bird's-eye view feature and the category feature is continuously approaching that of the second target detection model, and a 3D target detection accuracy of the first target detection model is improved. In application, only the first target detection model is retained, a branch where the second target detection model is located is eliminated, and the running speed and detection accuracy of the first target detection model are both ensured. Moreover, more samples do not need to be added for training the first target detection model with higher detection accuracy, thereby improving the accuracy of monocular 3D detection and reducing training costs without increasing additional computation and training data.

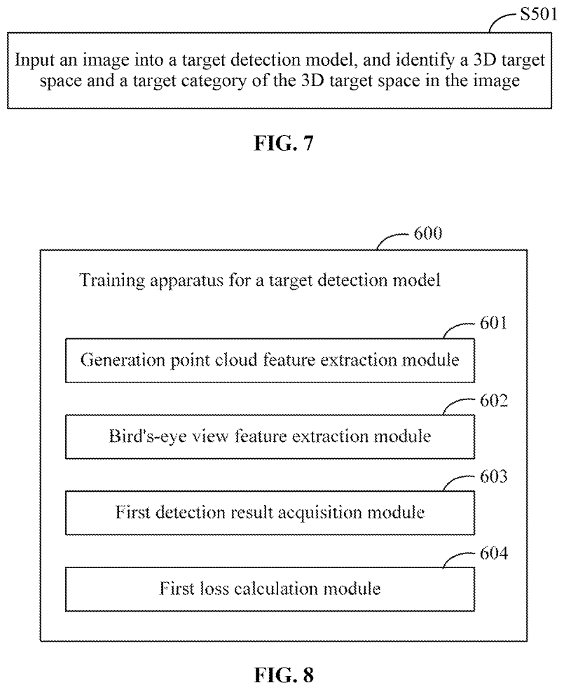

FIG. 7 is a flowchart of a target detection method according to an embodiment of the present disclosure. This embodiment may be applied to a case of identifying a space and category of a 3D object according to a trained target detection model and a monocular image. The method of this embodiment may be performed by a target detection apparatus. The apparatus may be implemented by software and/or hardware and is specifically configured in an electronic device having a certain data computing capability. The electronic device may be a client device or a server device. The client device is, for example, a mobile phone, a tablet computer, an in-vehicle terminal, a desktop computer and the like.

In S501, an image is inputted into a target detection model, and a 3D target space and a target category of the 3D target space are identified in the image; where the target detection model is trained and obtained according to the training method for a target detection model according to any embodiment of the present disclosure.

The image is a 2D monocular image for a 3D object that needs to be identified. The 3D target space surrounds the 3D object. The target category of the 3D target space refers to a category of an object surrounded by the 3D target space.

For example, in a field of traffic, a camera on a vehicle collects an image of a road scene ahead and inputs the image into the target detection model so as to obtain a target space in the road scene ahead where the target category is a vehicle, a target space where the target category is a pedestrian, a target space where the target category is an indicator light and the like.

For another example, in a cell monitoring scene, a camera configured in the cell collects an image of the cell scene. The image is inputted into the target detection model so as to obtain a target space in the cell scene where the target category is the elderly, a target space where the target category is children, a target space where the target category is the vehicle and the like.

According to the technical solution of the present disclosure, the target detection model is obtained through the training method for a target detection model according to any embodiment of the present disclosure, and target detection is performed on the image based on the target detection model so as to obtain the 3D target space and the corresponding target category, thereby improving the accuracy of 3D target detection, speeding up a detection efficiency of target detection, and reducing the computational cost and deployment cost of target detection.

According to an embodiment of the present disclosure, FIG. 8 is a structural diagram of a training apparatus for a target detection model according to an embodiment of the present disclosure, and the embodiment of the present disclosure is applicable to a case of training a target detection model for achieving 3D target detection. The apparatus is implemented by software and/or hardware and is specifically configured in an electronic device having a certain data computing capability.

As shown in FIG. 8, a training apparatus 600 for a target detection model includes a generation point cloud feature extraction module 601, a bird's-eye view feature extraction module 602, a first detection result acquisition module 603, and a first loss calculation module 604.

The generation point cloud feature extraction module 601 is configured to input a sample image into a point cloud feature extraction network of a first target detection model to obtain an image feature of a generation point cloud.

The bird's-eye view feature extraction module 602 is configured to input the image feature of the generation point cloud into a first bird's-eye view feature extraction network of the first target detection model to obtain a first bird's-eye view feature.

The first detection result acquisition module 603 is configured to input the first bird's-eye view feature into a prediction network of the first target detection model to obtain a first detection result.

The first loss calculation module 604 is configured to calculate a first loss according to a standard 3D recognition result of the sample image and the first detection result and train the first target detection model according to the first loss.

According to the technical solution of the present disclosure, the depth information is predicted through the sample image, the generation point cloud is determined, the image feature is extracted, and the image feature of the generation point cloud is obtained and converted into the first bird's-eye view feature so that 3D objects may be accurately distinguished in the depth direction, and the 3D objects are predicted based on the first bird's-eye view feature, thereby improving a target detection accuracy of the 3D objects.

Further, the generation point cloud feature extraction module 601 includes an image feature extraction unit, a pixel depth calculation unit, and a generation point cloud feature determination unit. The image feature extraction unit is configured to input the sample image into an encoder in the point cloud feature extraction network to obtain an image feature of the sample image. The pixel depth calculation unit is configured to input the image feature into a depth prediction network to obtain depths of pixels in the sample image. The generation point cloud feature determination unit is configured to, according to the depths of the pixels in the sample image, convert the pixels in the sample image into the generation point cloud, and according to the image feature, determine the image feature of the generation point cloud.

Further, the pixel depth calculation unit includes a depth confidence calculation subunit and a pixel depth prediction subunit. The depth confidence calculation subunit is configured to input the image feature into the depth prediction network and determine depth prediction confidences corresponding to the pixels in the sample image in preset candidate depth intervals. The pixel depth prediction subunit is configured to calculate the depths of the pixels according to intermediate depth values of the candidate depth intervals and the depth prediction confidences corresponding to the pixels in the candidate depth intervals.

Further, the training apparatus for a target detection model further includes a point cloud collection module, a point cloud of interest acquisition module, and a depth interval dividing module. The point cloud collection module is configured to acquire a collection point cloud, where the collection point cloud and the sample image correspond to a same collection scene. The point cloud of interest acquisition module is configured to acquire a point cloud of interest in the collection point cloud. The depth interval dividing module is configured to, according to a depth of the point cloud of interest, divide a depth of the collection scene corresponding to the collection point cloud into intervals and determine the candidate depth intervals.

Further, the training apparatus for a target detection model further includes a second bird's-eye view feature extraction module and a feature consistency loss calculation module. The second bird's-eye view feature extraction module is configured to input a collection point cloud into a second target detection model to obtain a second bird's-eye view feature. The feature consistency loss calculation module is configured to determine a feature difference according to the first bird's-eye view feature and the second bird's-eye view feature and calculate a feature consistency loss according to the feature difference and a standard region, where the standard region is a region where the standard 3D recognition result is projected in the sample image. The first loss calculation module 604 includes a feature loss training unit configured to train the first target detection model according to the first loss and the feature consistency loss.

Further, the first bird's-eye view feature includes a feature outputted by at least one first feature layer in the first bird's-eye view feature extraction network; the second target detection model includes a second bird's-eye view feature extraction network, the second bird's-eye view feature includes a feature outputted by at least one second feature layer in the second bird's-eye view feature extraction network, and the at least one first feature layer corresponds to the at least one second feature layer. The feature consistency loss calculation module includes a feature layer difference calculation unit configured to, according to a difference between the feature outputted by the at least one first feature layer and the feature outputted by the corresponding at least one second feature layer, calculate a difference corresponding to the at least one first feature layer and determine the feature difference.

Further, the first detection result includes a first category confidence. The apparatus further includes a confidence calculation module and a confidence loss calculation module. The confidence calculation module is configured to input the collection point cloud into the second target detection model to obtain a second detection result, where the second detection result includes a second category confidence. The confidence loss calculation module is configured to, in the case where the first detection result matches the second detection result, according to the first category confidence included in the first detection result and the second category confidence included in the second detection result, calculate a confidence loss of the first detection result and determine a confidence consistency loss. The first loss calculation module 604 includes a confidence loss training unit configured to train the first target detection model according to the first loss, the feature consistency loss, and the confidence consistency loss.

The training apparatus for a target detection model may perform the training method for a target detection model provided by any embodiment of the present disclosure and has function modules and beneficial effects corresponding to the performed training method for a target detection model.

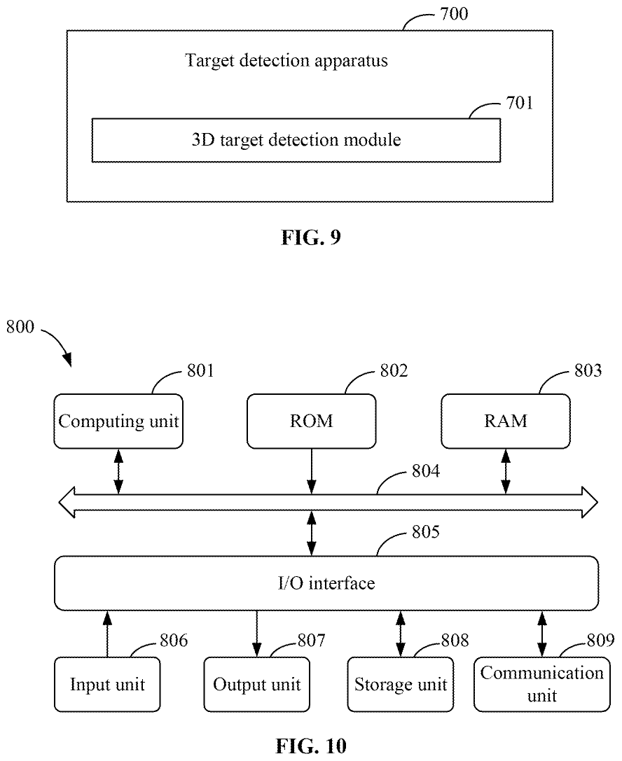

According to an embodiment of the present disclosure, FIG. 9 is a structural diagram of a target detection apparatus according to an embodiment of the present disclosure. The embodiment of the present disclosure is applicable to a case of identifying a space and category of a 3D object according to a trained target detection model and a monocular image. The apparatus is implemented by software and/or hardware and is specifically configured in an electronic device having a certain data computing capability.

As shown in FIG. 9, a target detection apparatus 700 includes a 3D target detection module 701.

The 3D target detection module 701 is configured to input an image into a target detection model and identify a 3D target space and a target category of the 3D target space in the image; where the target detection model is trained and obtained according to the training method for a target detection model according to any embodiment of the present disclosure.

According to the technical solution of the present disclosure, the target detection model is obtained through the training method for a target detection model according to any embodiment of the present disclosure, and target detection is performed on the image based on the target detection model so as to obtain the 3D target space and the corresponding target category, thereby improving the accuracy of 3D target detection, speeding up a detection efficiency of target detection, and reducing the computational cost and deployment cost of target detection.

The preceding target detection apparatus may perform the target detection method provided by any embodiment of the present disclosure and has function modules and beneficial effects corresponding to the performed target detection method.

In the technical solutions of the present disclosure, the collection, storage, use, processing, transmission, provision, and disclosure of user personal information involved are in compliance with provisions of relevant laws and regulations and do not violate public order and good customs.

According to an embodiment of the present disclosure, the present disclosure further provides an electronic device, a readable storage medium, and a computer program product.

FIG. 10 is a schematic diagram of an exemplary electronic device 800 that may be used for implementing the embodiments of the present disclosure. The electronic device is intended to represent various forms of digital computers, for example, a laptop computer, a desktop computer, a worktable, a personal digital assistant, a server, a blade server, a mainframe computer or another applicable computer. The electronic device may also represent various forms of mobile devices, for example, a personal digital assistant, a cellphone, a smartphone, a wearable device or another similar computing device. Herein the shown components, the connections and relationships between these components, and the functions of these components are illustrative only and are not intended to limit the implementation of the present disclosure as described and/or claimed herein.

As shown in FIG. 10, the device 800 includes a computing unit 801. The computing unit 801 may perform various types of appropriate operations and processing based on a computer program stored in a read-only memory (ROM) 802 or a computer program loaded from a storage unit 808 to a random-access memory (RAM) 803. Various programs and data required for operations of the device 800 may also be stored in the RAM 803. The computing unit 801, the ROM 802 and the RAM 803 are connected to each other through a bus 804. An input/output (I/O) interface 805 is also connected to the bus 804.

Multiple components in the device 800 are connected to the I/O interface 805. The components include an input unit 806 such as a keyboard and a mouse, an output unit 807 such as various types of displays and speakers, the storage unit 808 such as a magnetic disk and an optical disc, and a communication unit 809 such as a network card, a modem and a wireless communication transceiver. The communication unit 809 allows the device 800 to exchange information/data with other devices over a computer network such as the Internet and/or various telecommunications networks.

The computing unit 801 may be various general-purpose and/or special-purpose processing components having processing and computing capabilities. Examples of the computing unit 801 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 801 executes various methods and processing described above, such as the training method for a target detection model or the target detection method. For example, in some embodiments, the training method for a target detection model or the target detection method may be implemented as a computer software program tangibly contained in a machine-readable medium such as the storage unit 808. In some embodiments, part or all of computer programs may be loaded and/or installed on the device 800 via the ROM 802 and/or the communication unit 809. When the computer programs are loaded into the RAM 803 and executed by the computing unit 801, one or more steps of the preceding training method for a target detection model or the preceding the target detection method may be performed. Alternatively, in other embodiments, the computing unit 801 may be configured, in any other suitable manner (for example, by means of firmware), to execute the training method for a target detection model or the target detection method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

Program codes for implementing the methods of the present disclosure may be compiled in any combination of one or more programming languages. The program codes may be provided for the processor or controller of a general-purpose computer, a special-purpose computer, or another programmable data processing apparatus to enable functions/operations specified in flowcharts and/or schematic diagrams to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disk read-only memory (CD-ROM), an optical memory device, a magnetic memory device, or any suitable combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. The clients and servers are usually far away from each other and generally interact through the communication network. The relationship between the clients and the servers arises by virtue of computer programs running on respective computers and having a client-server relationship to each other. The server may be a cloud server, a server of a distributed system or a server combined with a blockchain.

It is to be understood that various forms of the preceding flows may be used with steps reordered, added, or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, subcombinations and substitutions may be made according to design requirements and other factors. Any modification, equivalent substitution, improvement and the like made within the spirit and principle of the present disclosure falls within the scope of the present disclosure.

What is claimed is:

1. A training method for a target detection model, comprising:
inputting a sample image into a point cloud feature extraction network of a first target detection model to obtain an image feature of a generation point cloud;
inputting the image feature of the generation point cloud into a first bird's-eye view feature extraction network of the first target detection model to obtain a first bird's-eye view feature;
inputting the first bird's-eye view feature into a prediction network of the first target detection model to obtain a first detection result; and
calculating a first loss according to a standard 3D recognition result of the sample image and the first detection result and training the first target detection model according to the first loss.

2. The method of claim 1, wherein inputting the sample image into the point cloud feature extraction network of the first target detection model to obtain the image feature of the generation point cloud comprises:
inputting the sample image into an encoder in the point cloud feature extraction network to obtain an image feature of the sample image;
inputting the image feature into a depth prediction network to obtain depths of pixels in the sample image; and
according to the depths of the pixels in the sample image, converting the pixels in the sample image into the generation point cloud, and according to the image feature, determining the image feature of the generation point cloud.

3. The method of claim 2, wherein inputting the image feature into the depth prediction network to obtain the depths of the pixels in the sample image comprises:
inputting the image feature into the depth prediction network and determining, in preset candidate depth intervals, depth prediction confidences corresponding to the pixels in the sample image; and
calculating the depths of the pixels according to intermediate depth values of the candidate depth intervals and the depth prediction confidences corresponding to the pixels in the candidate depth intervals.

4. The method of claim 3, further comprising:
acquiring a collection point cloud, wherein the collection point cloud and the sample image correspond to a same collection scene;
acquiring a point cloud of interest in the collection point cloud; and
according to a depth of the point cloud of interest, dividing a depth of the collection scene corresponding to the collection point cloud into intervals and determining the candidate depth intervals.

5. The method of claim 1, further comprising:
inputting a collection point cloud into a second target detection model to obtain a second bird's-eye view feature; and
determining a feature difference according to the first bird's-eye view feature and the second bird's-eye view feature and calculating a feature consistency loss according to the feature difference and a standard region, wherein the standard region is a region where the standard 3D recognition result is projected in the sample image;
wherein training the first target detection model according to the first loss comprises:
training the first target detection model according to the first loss and the feature consistency loss.

6. The method of claim 5, wherein the first bird's-eye view feature comprises a feature outputted by at least one first feature layer in the first bird's-eye view feature extraction network; the second target detection model comprises a second bird's-eye view feature extraction network, the second bird's-eye view feature comprises a feature outputted by at least one second feature layer in the second bird's-eye view feature extraction network, and the at least one first feature layer corresponds to the at least one second feature layer;
determining the feature difference according to the first bird's-eye view feature and the second bird's-eye view feature comprises:
according to a difference between the feature outputted by the at least one first feature layer and the feature outputted by the corresponding at least one second feature layer, calculating a difference corresponding to the at least one first feature layer and determining the feature difference.

7. The method of claim 5, wherein the first detection result comprises a first category confidence;
wherein the method further comprises:
inputting the collection point cloud into the second target detection model to obtain a second detection result, wherein the second detection result comprises a second category confidence; and
in a case where the first detection result matches the second detection result, according to the first category confidence comprised in the first detection result and the second category confidence comprised in the second detection result, calculating a confidence loss of the first detection result and determining a confidence consistency loss;
training the first target detection model according to the first loss and the feature consistency loss comprises:
training the first target detection model according to the first loss, the feature consistency loss, and the confidence consistency loss.

8. A target detection method, comprising:
inputting an image into a target detection model and identifying a 3D target space and a target category of the 3D target space in the image;
wherein the target detection model is trained and obtained by:
inputting a sample image into a point cloud feature extraction network of a first target detection model to obtain an image feature of a generation point cloud;
inputting the image feature of the generation point cloud into a first bird's-eye view feature extraction network of the first target detection model to obtain a first bird's-eye view feature;
inputting the first bird's-eye view feature into a prediction network of the first target detection model to obtain a first detection result; and
calculating a first loss according to a standard 3D recognition result of the sample image and the first detection result and training the first target detection model according to the first loss.

9. A training apparatus for a target detection model, comprising:
at least one processor; and
a memory communicatively connected to the at least one processor, wherein
the memory stores instructions executable by the at least one processor, and the instructions are executed by the at least one processor to cause the at least one processor to:
input a sample image into a point cloud feature extraction network of a first target detection model to obtain an image feature of a generation point cloud;
input the image feature of the generation point cloud into a first bird's-eye view feature extraction network of the first target detection model to obtain a first bird's-eye view feature;
input the first bird's-eye view feature into a prediction network of the first target detection model to obtain a first detection result; and
calculate a first loss according to a standard 3D recognition result of the sample image and the first detection result and train the first target detection model according to the first loss.

10. The apparatus of claim 9, wherein the processor inputs the sample image into the point cloud feature extraction network of the first target detection model to obtain the image feature of the generation point cloud by:
inputting the sample image into an encoder in the point cloud feature extraction network to obtain an image feature of the sample image;
inputting the image feature into a depth prediction network to obtain depths of pixels in the sample image; and
according to the depths of the pixels in the sample image, converting the pixels in the sample image into the generation point cloud, and according to the image feature, determining the image feature of the generation point cloud.

11. The apparatus of claim 10, wherein the processor inputs the image feature into the depth prediction network to obtain the depths of the pixels in the sample image by:
inputting the image feature into the depth prediction network and determining, in preset candidate depth intervals, depth prediction confidences corresponding to the pixels in the sample image; and
calculating the depths of the pixels according to intermediate depth values of the candidate depth intervals and the depth prediction confidences corresponding to the pixels in the candidate depth intervals.

12. The apparatus of claim 11, wherein the processor is further configured to:
acquire a collection point cloud, wherein the collection point cloud and the sample image correspond to a same collection scene;
acquire a point cloud of interest in the collection point cloud; and
according to a depth of the point cloud of interest, divide a depth of the collection scene corresponding to the collection point cloud into intervals and determine the candidate depth intervals.

13. The apparatus of claim 9, wherein the processor is further configured to:
input a collection point cloud into a second target detection model to obtain a second bird's-eye view feature; and
determine a feature difference according to the first bird's-eye view feature and the second bird's-eye view feature and calculate a feature consistency loss according to the feature difference and a standard region, wherein the standard region is a region where the standard 3D recognition result is projected in the sample image;
wherein the processor trains the first target detection model according to the first loss by:
training the first target detection model according to the first loss and the feature consistency loss.

14. The apparatus of claim 13, wherein the first bird's-eye view feature comprises a feature outputted by at least one first feature layer in the first bird's-eye view feature extraction network; the second target detection model comprises a second bird's-eye view feature extraction network, the second bird's-eye view feature comprises a feature outputted by at least one second feature layer in the second bird's-eye view feature extraction network, and the at least one first feature layer corresponds to the at least one second feature layer;
wherein the processor determines the feature difference according to the first bird's-eye view feature and the second bird's-eye view feature by:
according to a difference between the feature outputted by the at least one first feature layer and the feature outputted by the corresponding at least one second feature layer, calculating a difference corresponding to the at least one first feature layer and determine the feature difference.

15. The apparatus of claim 13, wherein the first detection result comprises a first category confidence;
wherein the processor is further configured to:
input the collection point cloud into the second target detection model to obtain a second detection result, wherein the second detection result comprises a second category confidence; and
in a case where the first detection result matches the second detection result, according to the first category confidence comprised in the first detection result and the second category confidence comprised in the second detection result, calculate a confidence loss of the first detection result and determine a confidence consistency loss;
wherein the processor trains the first target detection model according to the first loss and the feature consistency loss by:
training the first target detection model according to the first loss, the feature consistency loss, and the confidence consistency loss.

16. A target detection apparatus, comprising:
at least one processor; and
a memory communicatively connected to the at least one processor, wherein
the memory stores instructions executable by the at least one processor, and the instructions are executed by the at least one processor to cause the at least one processor to:
input an image into a target detection model and identify a 3D target space and a target category of the 3D target space in the image; wherein the target detection model is trained and obtained according to the training apparatus for a target detection model of claim 9.

17. A non-transitory computer-readable storage medium storing computer instructions for causing a computer to perform the training method for a target detection model of claim 7.
